(19) United States
(12) Patent Application Publication
(10) Pub. No.: US 2013/0287602 A1
(43) Pub. Date: Oct. 31, 2013

(54) Motor Control Device And Refrigerator

(71) Applicant: HITACHI, LTD., Tokyo (JP)

(72) Inventors: Takahiro SUZUKI, Naka-gun (JP); Yuichi SHIMIZU, Sano (JP); Hiroto ISHIWATARI, Oyama (JP); Yasuo NOTOHARA, Hitachiota (JP)

(73) Assignee: Hitachi, Ltd., Tokyo (JP)

(21) Appl. No.: 13/859,063

(22) Filed: Apr. 9, 2013

(30) Foreign Application Priority Data
Apr. 27, 2012 (JP) 2012-101962

(51) Int. Cl. F04B 17/03; H02P 6/10

(52) U.S. Cl. CPC F04B 17/03; H02P 6/10
USPC 417/410.1; 318/400.23

(57) ABSTRACT

A motor control device includes an electric power conversion circuit, an electric current detection unit, a load fluctuation detection unit, and an adjustment unit. The conversion circuit supplies AC power to a motor configured to drive a mechanism unit by converting DC power into AC power. The current detection unit detects the electric current flowing through the conversion circuit or the motor. The load fluctuation detection unit detects the periodic fluctuation of the load of the motor, based on the electric current. The adjustment unit adjusts a phase of the AC voltage of the AC power, by controlling the conversion circuit based on the fluctuation. The phase of the AC voltage has a first component that increases with respect to a magnetic pole position of the motor, and a second component that changes in synchronization with the fluctuation.

### BACKGROUND OF THE INVENTION

1. Field of the Invention

The present invention relates to a technique of controlling a motor.

2. Background Art

A technique of correcting an output frequency or an output voltage of an inverter so as to suppress a torque pulsation and increasing a correction rate when an operation frequency is a predetermined value or less, and a technique of controlling the output voltage and the output frequency of the inverter depending on a peak value of a motor current and a change thereof have been known (for example, JP-A-2005-65449 and JP-A-2009-27871).

As mentioned above, in the motor control device having a structure that corrects the output frequency or the output voltage of the inverter, it is not considered that, when the number of revolutions of the motor is high, and an induced voltage increases, the output voltage of the inverter is limited, that is, in a weak field magnetic region, the torque pulsation is suppressed.

Furthermore, as mentioned above, in a motor control device having the structure that detects the peak value of the electric current flowing through the motor and controls the inverter output voltage so that the electric current phase of the motor becomes substantially the same phase as a q axis depending on the load torque, for example, the application to a motor such as a reluctance motor, in which the electric current phase having the minimum electric current is different from the q axis, has not been considered.

### SUMMARY OF THE INVENTION

In order to solve the above-mentioned problems, according to an aspect of the present invention, a motor control device includes an electric power conversion circuit, an electric current detection unit, a load fluctuation detection unit, and an adjustment unit. The electric power conversion circuit supplies the motor configured to drive a mechanism unit with AC electric power, by converting DC electric power into AC electric power. The electric current detection unit detects the electric current flowing through the electric power conversion circuit or the motor. The load fluctuation detection unit detects a periodic fluctuation of the load of the motor, based on the electric current. The adjustment unit adjusts the phase of the AC voltage of the AC electric power, by controlling the electric power conversion circuit based on the fluctuation. The period of the fluctuation is an integral multiplication of a mechanical angle 1 period of the motor. The phase of the AC voltage has a first component that increases with respect to a magnetic pole position of the motor, and a second component that is changed in synchronization with the fluctuation.

According to the present invention, by suppressing the periodic load fluctuation regardless of the number of revolutions of the motor, the rotation of the motor can be stabilized.

### BRIEF DESCRIPTION OF THE DRAWINGS

FIG. 1 illustrates a configuration of a drive apparatus in Embodiment 1.

FIG. 2 illustrates a configuration of an electric power conversion circuit 5 in Embodiment 1.

FIG. 3 illustrates a relationship between a real axis and a control axis.

FIG. 4 illustrates a relationship between a three-phase axis as a fixed coordinate system and the control axis.

FIG. 5 is a plan view that illustrates a compressor 510.

FIG. 6 is a front view that illustrates the compressor 510.

FIG. 7 illustrates the fluctuation of the periodic load torque.

FIG. 8 illustrates a configuration of a control unit 2.

FIG. 9 illustrates a configuration of a PLL controller 13.

FIG. 10 illustrates a simulation result of the fluctuation of the load torque.

FIG. 11 illustrates a configuration of a speed controller 14.

FIG. 12 illustrates an induced voltage and a speed fluctuation width in a weak field magnetic region.

FIG. 13 illustrates a configuration of a period torque estimation unit 30.

FIG. 14 illustrates a configuration of a voltage phase adjuster 7.

FIG. 15 illustrates a voltage command phase.

FIG. 16 illustrates a time change of the voltage phase that is output from the electric power conversion circuit 5.

FIG. 17 illustrates a modified example of the voltage phase adjuster 7a.

FIG. 18 illustrates a first modified example of the control unit 2.

FIG. 19 illustrates a second modified example of the control unit 2.

FIG. 20 illustrates a third modified example of the control unit 2.

FIG. 21 illustrates a configuration of a refrigerator in Embodiment 2.

FIG. 22 illustrates a configuration of an electric power conversion circuit 5a in Embodiment 2.

FIG. 23 illustrates efficiency with respect to the number of revolutions of the motor 6.

FIG. 24 illustrates a modified example of the control unit and the electric power conversion circuit in Embodiment 2.

FIG. 25 illustrates a time change of a DC voltage command value after the adjustment.

### DESCRIPTION OF EMBODIMENTS

Hereinafter, examples of the present invention will be described using the drawings.

### Embodiment 1

In this embodiment, a drive apparatus as an application example of the motor control device of the present invention will be described. The drive apparatus has a compression mechanism unit that is driven by the motor.

### Overall Configuration

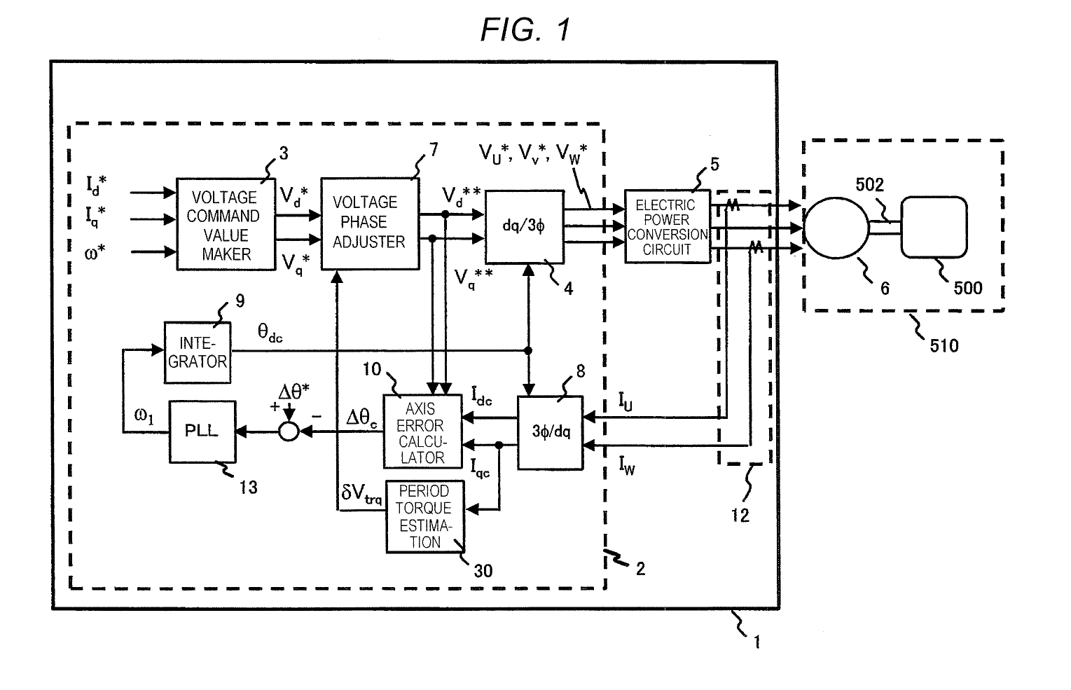

FIG. 1 illustrates a configuration of the drive apparatus in Embodiment 1. The drive apparatus has a motor control device 1, and a compressor 510. The compressor 510 has a motor (an electric motor) 6, and a compression mechanism unit 500. The motor control device 1 has an electric power conversion circuit 5 that outputs a three-phase AC voltage using a DC voltage source, an electric current detection unit 12 that detects the electric current flowing through the motor 6 or the electric power conversion circuit 5, and a control unit 2 that calculates a voltage command value applied to the motor 6 on the basis of the electric current information detected by the electric current detection unit 12. The details of the control unit 2 will be described later. The motor 6 is controlled by the electric power conversion circuit 5. The compression mechanism unit 500 is connected to the motor 6 via a shaft 502.

### Configuration of Electric Power Conversion Circuit 5

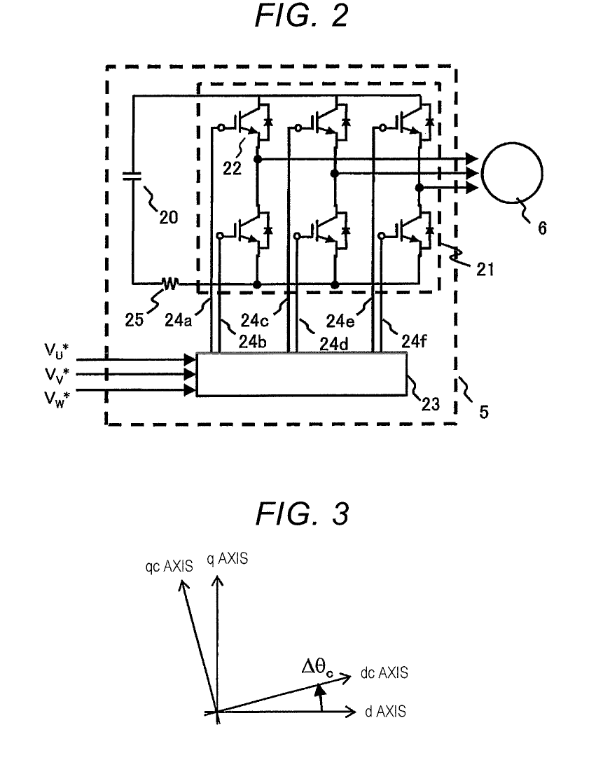

FIG. 2 illustrates a configuration of the electric power conversion circuit 5 in Embodiment 1. The electric power conversion circuit 5 has an inverter 21, a DC voltage source 20, and a driver circuit 23. The inverter 21 is constituted by three pairs of switching elements 22 (for example, semiconductor switching elements such as IGBT (Insulated Gate Bipolar Transistor), MOS-FET (Metal Oxide Semiconductor-Field Effect Transistor)). The two switching elements 22 forming each pair are connected to each other in series to constitute upper and lower arms. The three pairs each constitute upper and lower arms of a U phase, a V phase, and a W phase. A connection point of the upper and lower arms of each phase is wired to the motor 6. The driver circuit 23 outputs pulsive drive signals 24a to 24f, on the basis of three-phase AC voltage command value (Vu*, Vv*, and Vw*) generated in the control unit 2. The switching elements 22 forming the three pairs perform the switching operation according to the drive signals 24a to 24f, respectively. The electric power conversion circuit 5 is able to apply the three-phase AC voltage of a certain frequency to the motor 6 by switching the DC voltage source 20 to output the voltage, thereby performing the variable-speed driving of the motor 6.

When adding a shunt resistor 25 to the DC side in the electric power conversion circuit 5, the shunt resistor 25 can be used for an over-current protection circuit for protecting the switching element 22 when an excessive electric current flows, a single shunt electric current detection method described later or the like.

### Definition of Coordinate Axis in Motor 6

This embodiment uses a permanent magnet motor having a permanent magnet in a rotor, as the motor 6. For that reason, the position of the control axis and the position of the rotor are basically synchronized with each other. The rotation angle position information of the rotor is assumed based on the information such as the electric current flowing through the motor 6, the motor application voltage or the like, by a position sensorless control. At that time, the position of the rotor in a magnetic flux direction is set to d axis, and a d-q axis (a rotation coordinate system) constituted by a q axis electrically advanced therefrom by 90° in the rotation direction is defined.

FIG. 3 illustrates a relationship between a real axis and a control axis. With respect to the d-q axis, a virtual rotor position on the control is set to a dc axis, a qc axis electrically advanced therefrom 90° in the rotation direction is set, and a dc-qc axis serving as a rotation coordinate system constituted by the dc axis and the qc axis is defined. This embodiment is based on the control of the voltage and the electric current on the dc-qc axis. In addition, in the following description, the d-q axis is referred to as a real axis, the dc-qc axis is referred to as the control axis, and an error of the control axis with respect to the real axis is referred to as an axis error (Δθc).

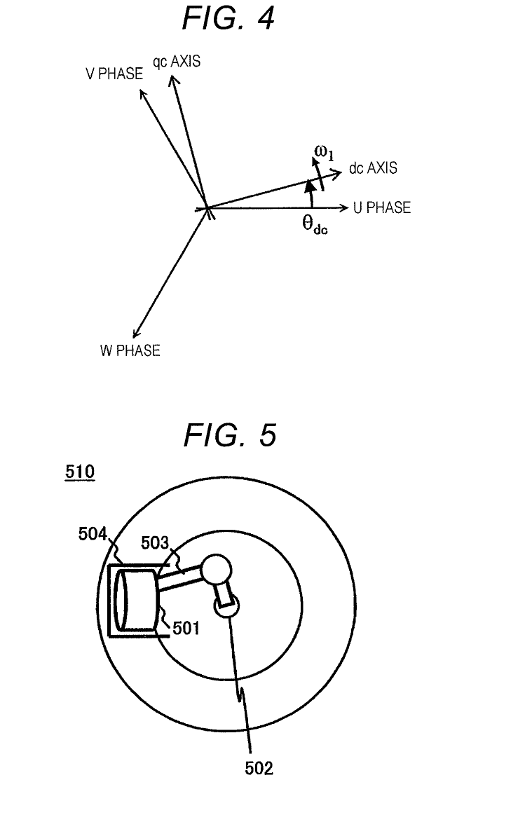

FIG. 4 illustrates a relationship between the three-phase axis and the control axis. The three-phase axis constituted by the U axis, the V axis, and the W axis is a fixed coordinate system. A magnetic pole position (θdc) serving as the rotation angle position of the dc axis is defined on the basis of the U phase. The dc axis rotates in a direction of an arrow (a counterclockwise direction) in the drawings, and the magnetic pole position (θdc) can be obtained by integrating the rotation frequency. The rotation frequency is an inverter frequency command value (Ω1) described later.

### Configuration of Compressor 510

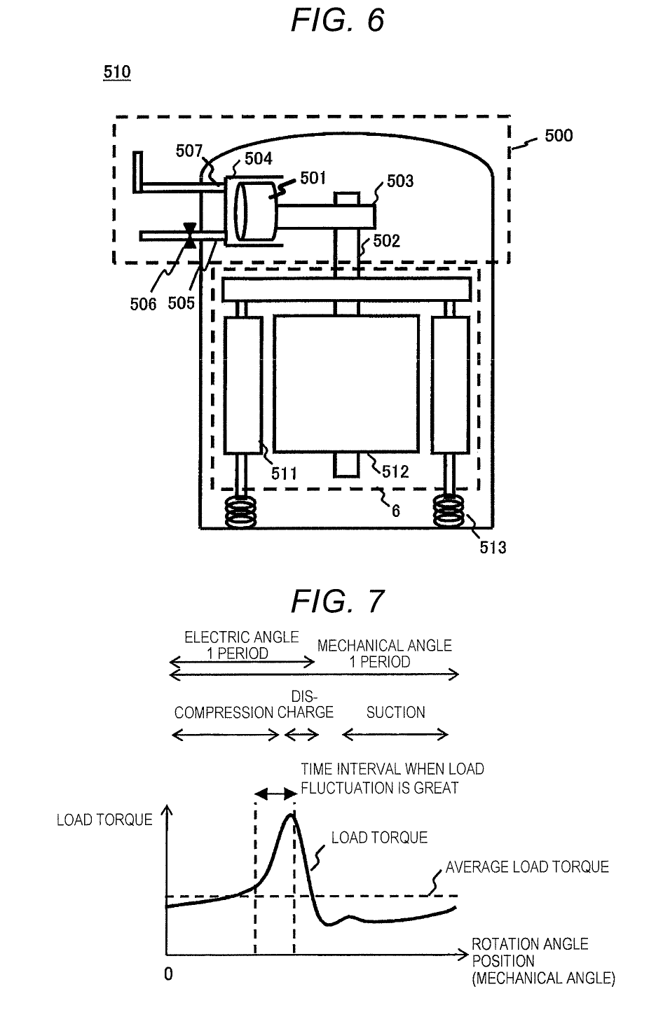

FIG. 5 is a plan view that illustrates a compressor 510. FIG. 6 is a front view that illustrates the compressor 510. The compressor 510 is a reciprocating compressor that drives the piston 501, using the motor 6 as the power source. The compressor 510 has a support mechanism 513, the motor 6, and the compression mechanism unit 500.

The motor 6 is supported by the support mechanism 513, and rotates by the AC electric current from the electric power conversion circuit 5. The motor 6 has a stator 511, and a rotor 512. The stator 511 has a coil through which the AC electric current from the motor control device 1 flows. The rotor 512 has a permanent magnet.

The compression mechanism unit 500 has a piston 501, a shaft 502, a crankshaft 503, a cylinder 504, a suction port 505, a valve 506, an exhaust port 507, and a support mechanism 513. The shaft 502 is connected to the rotor 512 of the motor 6, and rotates together with the rotor 512. The crankshaft 503 is connected to the shaft 502, and converts the rotary movement of the shaft 502 into a linear movement of the piston 501. The piston 501 reciprocates according to the rotation of the motor 6, whereby a series of processes such as suction, compression, and discharge is performed. In the compression operation, first, the compression mechanism unit 500 sucks the refrigerant from the suction port 505 provided in the cylinder 504 into the cylinder 504. Thereafter, the compression mechanism unit 500 closes the valve 506, compresses the refrigerant in the cylinder 504, and discharges the compressed refrigerant from the discharge port 507.

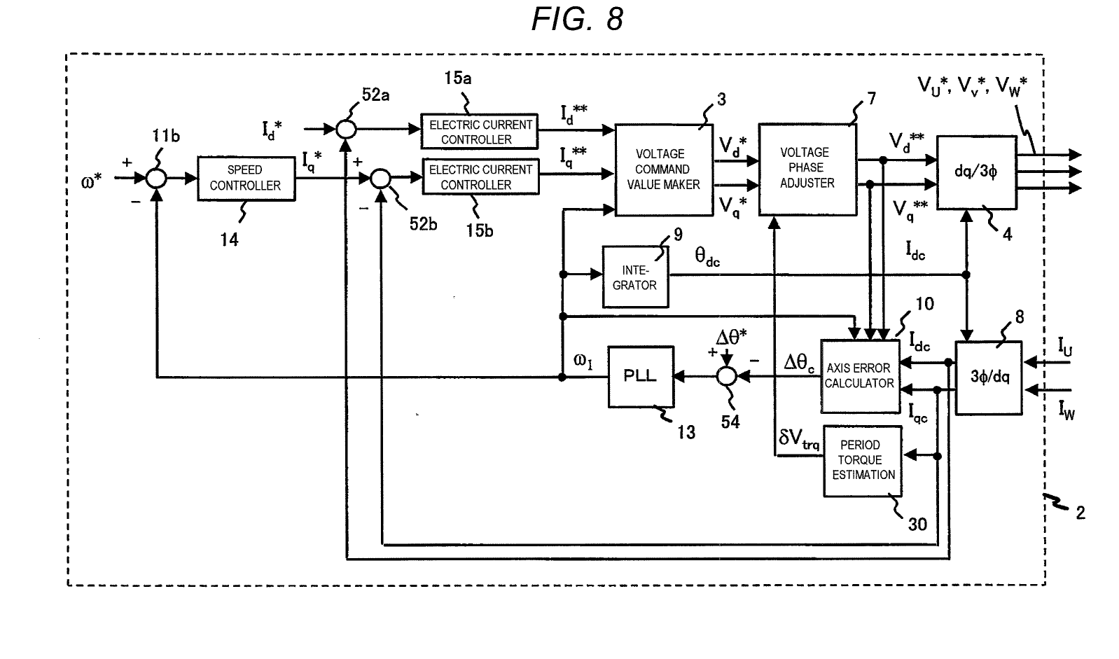

In the series of processes, the pressure applied to the piston 501 changes. This means that the load torque periodically changes when viewed from the motor 6 driving the piston 501. FIG. 7 illustrates the fluctuation of the periodic load torque. FIG. 7 illustrates a change of the load torque with respect to the rotation angle position of the rotor, in one rotation of the mechanical angle of the motor 6. Herein, since a case where the motor 6 is a four-pole motor, is shown, the electric angle 2 period corresponds to the mechanical angle 1 period. Although the position relationship between the position of the rotor and the piston 501 is defined by assembling, FIG. 7 illustrates a change of the load torque with respect to the piston position when a bottom dead center of the piston 501 is 0° of the mechanical angle. As the compression process progresses, the load torque increases, and in the discharge process, it is characterized in that the load torque rapidly decreases. In FIG. 7, a time interval when the load fluctuation is particularly high is shown. It is understood that the load torque fluctuates during one rotation, from FIG. 7. Since the load torque fluctuates whenever the motor 6 rotates, the load torque periodically fluctuates when viewed from the motor 6.

Even if the same compression mechanism unit 500 is used, the fluctuation of the load torque changes, due to the number of revolutions of the motor 6, the pressures of the suction port 505 and the discharge port 507, a pressure difference between the suction port 505 and the discharge port 507 or the like. A relationship between the open and close timing of the valve 506 and the position of the piston changes by the configuration of the valve 506. For example, when using a simple valve that is operated due to a pressure difference between the suction port 505 and the inside of the cylinder 504; the open and close timing of the valve 506 changes by the pressure condition. That is, the maximum piston position also changes during one rotation of the load torque. In this manner, since the periodic load torque changes due to various factors, in order to suppress the periodic load fluctuation and stably drive the motor 6 in the wide operation ranges, the feedback control is suitable.

In this embodiment, although the piston 501 of the compression mechanism unit 500 of the reciprocating type moving linearly is described as an example, as other compression types in the compression mechanism, there is a rotary type of compressing by the rotation of the piston, a scroll type constituted by a spiral turning blade or the like. The characteristics of the periodic load fluctuation differ by the respective compression types, but there is a load fluctuation due to the compression process in any compression type. For that reason, the motor control device 1 of this embodiment can be similarly applied to the compression mechanism of the different compression method, and the same effect as this embodiment can be obtained.

### Configuration of Electric Current Detection Unit 12

The electric current detection unit 12 detects the electric current flowing in the U phase and the W phase in the AC electric current of three-phases flowing through the motor 6 or the electric power conversion circuit 5. Although the AC electric current of the all phases may be detected, if two-phases among the three-phases can be detected, the other one phase can be calculated from the detected two phases from Kirchhoff's law.

Furthermore, as another detection method of detecting the AC electric current flowing through the motor 6 or the electric power conversion circuit 5, for example, a single shunt electric current detection method may be used which detects the electric current of the AC side in the electric power conversion circuit 5 from the DC electric current flowing through a shunt resistor 25 added to the DC side in the electric power conversion circuit 5. This detection method uses the electric current equal to the AC electric current of each phase of the electric power conversion circuit 5 that flows though the shunt resistor 25, by the conduction state of the switching element 22 that constitutes the electric power conversion circuit 5. Since the electric current flowing through the shunt resistor 25 changes in time, there is a need to detect the electric current at a suitable timing based on the timing when the drive signals 24a to 24f change. In addition, in the electric current detection unit 12, a single shunt electric current detection method may be used.

### Configuration of Control Unit 2

FIG. 8 illustrates a configuration of the control unit 2. The control unit 2 has a 3φ/dq converter 8 that performs the coordinate conversion of the AC electric current detection values (Iu and Iw) on three-phase axis into the electric current value on the control axis, an axis error calculator 10 that calculates an axis error (Δθc) between the real axis and the control axis using the electric current detection values (Idc and Iqc) on the control axis and the voltage command values (Vd** and Vq**) applied to the motor 6, a PLL controller 13 that adjusts the inverter frequency command value (ω1) serving as the frequency of the voltage applied to the motor 6 so as to cause the axis error (Δθc) to follow the axis error command value (Δθ*: normally zero), a voltage command value maker 3 that calculates a d axis voltage command value (Vd*) and a q axis voltage command value (Vq*) based on the d axis electric current detection value (Id**), the q axis electric current detection value (Iq**) and the inverter frequency command value (ω1), a voltage phase adjuster 7 that adjusts the phase of the voltage command values (Vd* and Vq) on the dc-qc axis based on the estimated load torque to calculate the voltage command values (Vd** and Vq**), a dq/3φ converter 4 that performs the coordinate conversion of the voltage command value (Vd** and Vq**) on the dc-qc axis into the three-phase axis from the control axis, and a periodic torque estimation unit 30 that estimates the load torque periodically fluctuating. The axis error (Δθc) is an error of the control axis with respect to the real axis, as illustrated in the above-mentioned view of a relationship between the real axis and the control axis.

Furthermore, the control unit 2 has a subtracter 11b that subtracts the inverter frequency command value (ω1) from the frequency command value (ω*), a speed controller 14 that calculates the q axis electric current command value (Iq*) from the output of the subtracter 11b, a subtracter 52a that subtracts the d axis electric current detection value (Idc) from the d axis electric current command value (id*) given from a higher control system or the like, a subtracter 52b for subtracting the q axis electric current detection value (Iqc) from the q axis electric current detection value (Iq*), an electric current controller 15a that calculates the d axis electric current detection value (Id**) from the output of the subtracter 52a, an electric current controller 15b that calculates the q axis electric current detection value (Iq**) from the output of the subtracter 52b, a subtracter 54 that subtracts the axis error (Δθc) from the axis error command value (Δθ*), an integrator 9 that integrates the inverter frequency command value (Ω1) to calculate the magnetic pole position (θdc), and a 3φ/dq converter 8 that performs the coordinate conversion of the motor electric current detection values (Iu and Iw) of the three-phase AC axis into the dc-qc axis.

Each unit of the control unit 2 may be constituted by a micro computer configured to execute processing according to the software, or a micro processor such as DSP, and may be constituted by hardware such as a semiconductor integrated circuit.

Hereinafter, the details of each component of the motor control device 1 will be described. First, a basic operation of the motor control method for driving the motor 6 will be described, and then the problem when there is a pulsation torque like the compression mechanism unit 500 will be described. Herein, the load torque periodically fluctuating is referred to as a pulsation torque, and the motor control for suppressing the pulsation torque is referred to as a pulsation torque control.

Motor Control Method when there is No Pulsation Torque Control

The control unit 2 performs the control by the use of the dc-qc axis (the rotation coordinate system) so as to drive motor 6, as mentioned above. Although there is a need to perform the coordinate conversion from the three-phase AC axis into the rotation coordinate, there is an advantage in that the voltage and the electric current can be handled as the DC amount on the rotation coordinate. For that reason, the 3φ/dq converter 8 performs the coordinate conversion of the motor electric current detection values (Iu and Iw) of the three-phase AC axis detected by the electric current detection unit 12 into the dc-qc axis by the use of the magnetic position (θdc), whereby the electric current detection values (Idc and Iqc) of the d axis and the q axis are obtained. Furthermore, the dq/3φ converter 4 performs the coordinate conversion of the voltage command values (Vd** and Vq**) on the dc-qc axis generated by the voltage command value maker 3 and the voltage phase adjuster 7 into the three-phase AC voltage command values (Vu*, Vv*, and Vω*) by the use of the magnetic position (θdc).

The voltage command value maker 3 acquires the electric current command values (Id* and Iq*) of the d axis and the q axis obtained from the higher control system or the like, and the frequency command value (ω*) or the inverter frequency command value (ω1), described later, and performs the vector calculation as the following formula, thereby obtaining the d axis voltage command value (Vd*) and the q axis voltage command values (Vq*).

Vd*=R×Id*−ω*×Lq×Iq*

Vq*=R×Iq*+ω*×Ld×Id*+ω*×Ke (1)

Herein, R is a coil resistance value of the motor 6, Ld is an inductance of the d axis, Lq is an inductance of the q axis, and Ke is an induced voltage constant.

Formula (1) is generally called vector control. The vector control separates the electric current flowing through the motor 6 into a field magnet component and a torque component to calculate, and controls the phase and the magnitude of the voltage so that the phase of the motor electric current becomes a predetermined phase.

The motor 6 of this embodiment is a non-salient pole type permanent magnet motor. That is, the inductance values of the d axis and the q axis are equal to each other. That is, the reluctance torque generated by a difference between the inductances of the d axis and the q axis is not considered. Thus, the generation torque of the motor 6 is proportional to the electric current flowing through the q axis. For that reason, in the present embodiment, the d axis electric current command value (Id*) is set to zero. In addition, in the case of a salient pole type, in addition to the torque due to the q axis electric current, there is a reluctance torque due to a difference in inductance between the d axis and the q axis. For that reason, by setting the d axis electric current command value (Id*) in consideration of the reluctance torque, the same torque can be generated at the small q axis electric current.

The axis error calculator 10 calculates the axis error (Δθc) between the real axis and the control axis by the following formula, by the use of the electric current detection values (Idc and Iqc) on the control axis and the voltage command values (Vd** and Vq**) applied to the motor 6.

$$Δ θ c = {tan}^{- 1} ( \frac{Vd ** - R \times Idc + ω 1 \times Lq \times Iqc}{Vq ** - R \times Iqc - ω 1 \times Lq \times Idc} )$$

The PLL controller 13 adjusts the inverter frequency command value (ω1) so that the axis error (Δθc) becomes the axis error command value (Δθ*: normally, zero).

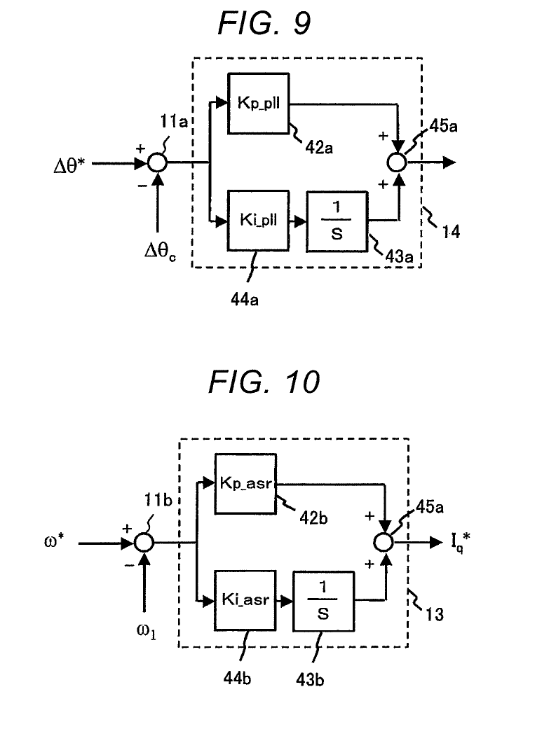

FIG. 9 illustrates a configuration of the PLL controller 13. The PLL controller 13 has a subtracter 11a, a proportional calculation unit 42a, an integration calculation unit 43a, an amplifier 44a, and an adder 45a. The subtracter 11a obtains the difference between the axis error command value (Δθ*) and the axis error (Δθc). The proportional calculation unit 42a multiplies the calculation result of the subtracter 11a by a proportional gain (Kp_pll) to perform the proportional control. The amplifier 44a multiplies the calculation result of the subtracter 11a by an integration gain (Ki_pll). The integration calculation unit 43a integrates and controls the calculation result of the amplifier 44a. The adder 45a adds the calculation result of the proportional calculation unit 42a and the calculation result of the integration calculation unit 43a, thereby to output the inverter frequency command value (Ω1).

Problem when there is No Pulsation Torque Control

FIG. 10 illustrates a configuration of the speed controller 14. Herein, the speed controller 14 calculates the q axis electric current command value (Iq*). The speed controller 14 has a subtracter 11b, a proportional calculation unit 42b, an integration calculation unit 43b, an amplifier 44b, and an adder 45b. The subtracter 11b obtains the difference between the frequency command value (ω*) and the inverter frequency command value (ω1). The proportional calculation unit 42b multiplies the calculation result of the subtracter 11b by a proportional gain (Kp_asr) to perform the proportional control. The amplifier 44b multiplies the calculation result of the subtracter 11b by an integration gain (Ki_asr). The integration calculation unit 43b integrates and controls the calculation result of the amplifier 44b. The adder 45b adds the calculation result of the proportional calculation unit 42b and the calculation result of the integration calculation unit 43b, thereby to output the q axis electric current command value (Iq*).

Normally, the period of the change of the frequency command value (ω*) given from the higher control system or the like is much longer than the period of the change of the inverter frequency command value (ω1), and may be considered to be a constant value during rotation of the motor position. For that reason, the motor 6 rotates substantially at a constant frequency by the speed controller 14. At this time, the magnetic pole position (θdc) obtained by integrating the inverter frequency command value (ω1) increases substantially at a constant speed.

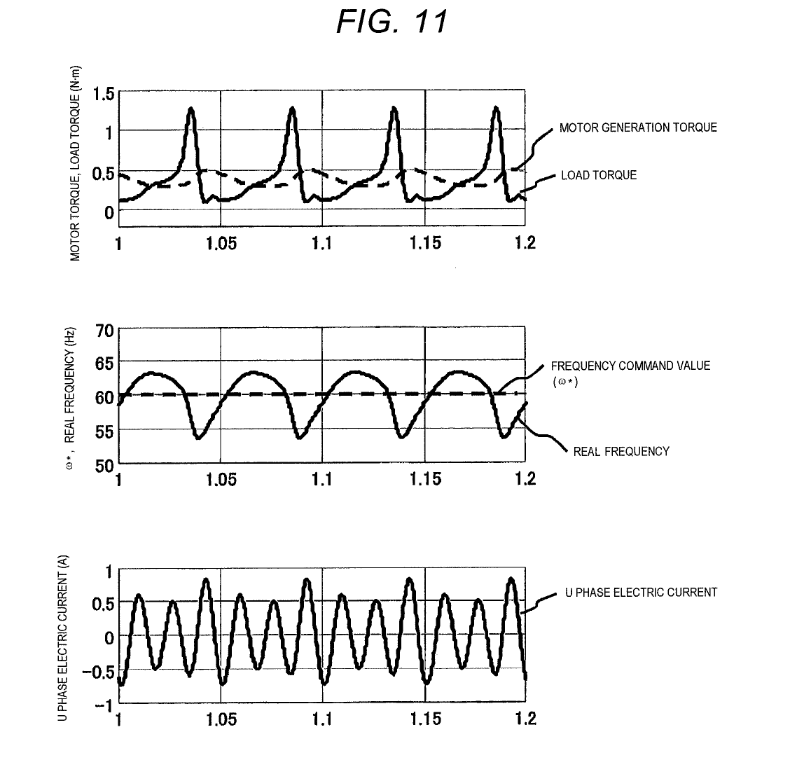

FIG. 11 illustrates a simulation result of the fluctuation of the load torque. This simulation result shows the motor generation torque, the load torque, the frequency command value (ω*), the real frequency, and the time change of the U-phase electric current. From this simulation result, it is understood that the motor generation torque, the real frequency of the motor 6 (the number of revolutions of the motor 6), the electric current flowing through the motor 6 and the like pulsate due to the fluctuation of the load torque during one rotation.

This is because there is a limitation in the response frequency capable of being set in the feedback control by the PLL controller 13, the electric current controllers 15a and 15b, the speed controller 14 or the like. For example, the settable response frequency of the PLL controller 13 is defined by an electric constant of the motor 6, and there is a need to set a lower response frequency as the inverter frequency is lower. In other words, as the motor 6 rotates at a lower speed, there is a need to set the response frequency of the PLL controller 13 to a lower level. Meanwhile, the settable response frequencies of the electric current controllers 15a and 15b are defined by the limitation of the calculation time of the control unit 2. That is, as the motor 6 rotates at a higher speed, there is a need to set the response frequencies of the electric current controllers 15a and 15b to a lower level. In this manner, it is difficult to suppress the periodic load fluctuation in a wide operation range only by the above-mentioned vector control.

When paying attention to the speed fluctuation of the motor 6, the speed fluctuation is obtained by the following formula.

$$Δ ω = \frac{1}{J} \int ( τ m - τ L ) d t$$

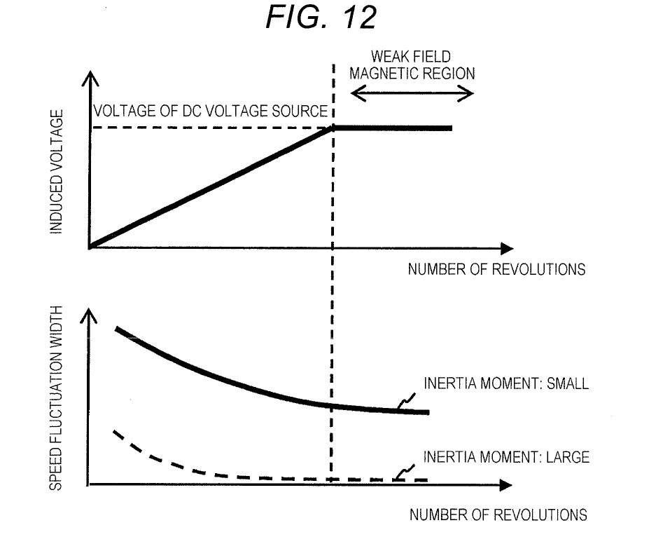

Herein, J is an inertia moment, τm is a generation torque of the motor 6, and τL is a load torque. As understood from this formula, the smaller the inertia moment of the motor 6 and the compression mechanism unit 500 is, the higher the speed fluctuation is. In addition, when the inertia moment is small, since the inertia is small, even when the motor 6 rotates at a high speed, in some cases, the speed fluctuation is remarkable. FIG. 12 illustrates the induced voltage and the speed fluctuation width in the weak field magnetic region. The range of the number of revolutions of the motor 6 in a case where the induced voltage generated between the terminals of the motor 6 is equal to or greater than the voltage of the DC voltage source 20 of the electric power conversion circuit 5 is referred to as a weak field magnetic region, and the range of the number of revolutions other than that range is referred to as a normal region. In the weak field magnetic region, in order to prevent the electric current from not flowing through the motor 6 from the motor control device 1, the electric current that cancels the magnetic flux of the motor 6 may flow.

Furthermore, in order to suppress the load fluctuation in the normal region, the q axis voltage command value may be controlled. In the weak field magnetic region, in some cases, there is also a need for the suppression of the periodic load fluctuation. For that reason, the motor controlling method of this embodiment suppresses the periodic load fluctuation even in the weak field magnetic region. In addition, the driving method of this embodiment is able to stably drive the motor 6, without requiring the conversion of the motor control method before and after the weak field magnetic control.

### Motor Control Method During Periodic Load Fluctuation

A period torque estimation unit 30 and a voltage phase adjuster 7 for suppressing the periodic load fluctuation will be described.

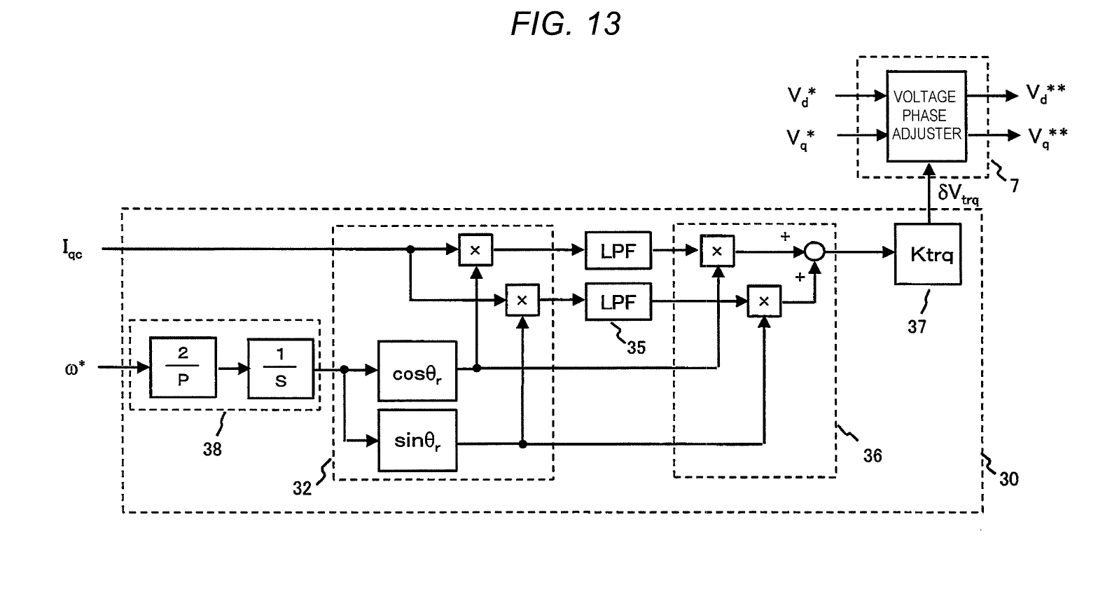

The period torque estimation unit 30 estimates or detects the load torque components periodically fluctuating, on the basis of the electric current information detected by the electric current detection unit 12. FIG. 13 illustrates a configuration of the period torque estimation unit 30. The period torque estimation unit 30 has a single-phase coordinate converter 32, a low pass filter (LPF) 35, a mechanical angle frequency component calculation unit 36, and an amplifier 37. The single-phase coordinate converter 32 performs the coordinate conversion of the q axis electric current detection value (Iqc) obtained from the 3φ/dq converter 8 into a coordinate system that rotates at a mechanical angle frequency (ωm).

For example, when the number of the magnetic poles of the rotor of the motor 6 is 4, the electric angle 2 period corresponds to the mechanical angle 1 period. For that reason, if the frequency command value (ω*: the electric angle) is divided by the number of the pair of the poles (=the number of poles/2) of the motor 6, the mechanical angle frequency (ωm) can be obtained. In addition, in this embodiment, in order to obtain the mechanical angle frequency, although the frequency command value (ω*) is used, the inverter frequency command value (ω1) may be used.

The coordinate conversion using the single-phase coordinate converter 32 is performed using the following formula.

Iq_cos=cos θr×Iqc

Iq_sin=sin θr×Iqc

Thereby, in the q axis electric current detection value (Iqc), a cos component (Iqc_cos) and a sin component (Iqc_sin) of the mechanical angle frequency (ωm) are calculated. As needed, the LPF 35 is used to remove a high-order component of, the fluctuation of the load torque or remove the noise of the electric current detection value. After that, the mechanical angle frequency component calculation unit 36 performs the coordinate conversion again, using the following formula.

Iqm_cos=cos θr×Iq_cos

Iqm_sin=sin θr×Iq_sin

Next, the mechanical angle frequency component calculation unit 36 calculates the component (Iqm) of the mechanical angle frequency (ωm) in the q axis electric current detection value (Iqc), by adding two calculation results obtained by this coordinate conversion. That is, by observing the change of the output of the mechanical angle frequency component calculation unit 36, it is possible to estimate the change of the periodic load torque that fluctuates at the mechanical angle frequency (ωm). As needed, the amplifier 37 is used to multiply the change of the estimated load torque by a gain (Ktrq), thereby obtaining an amount of voltage phase adjustment (δVtrq). The amount of voltage phase adjustment (δVtrq) is input to the voltage phase adjuster 7.

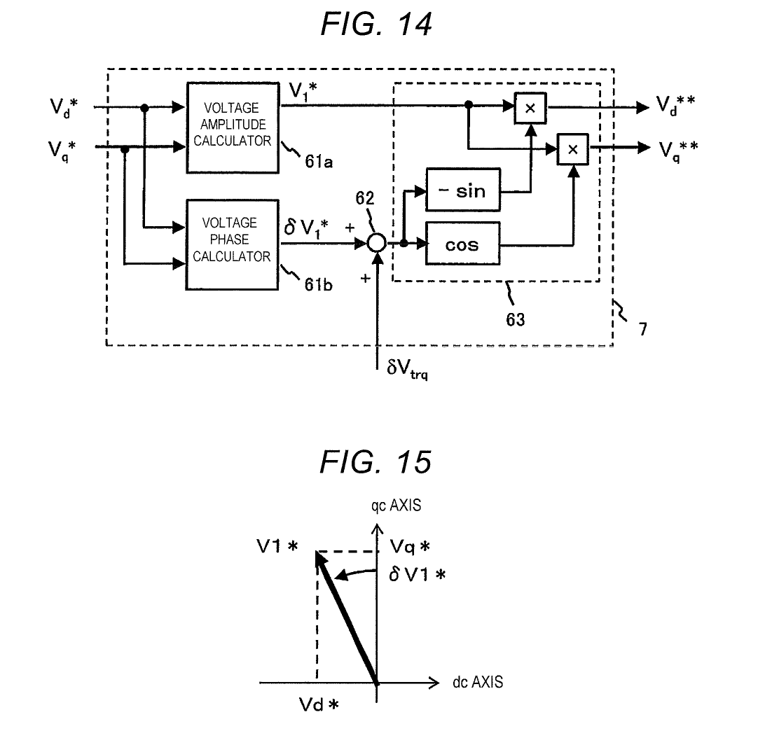

FIG. 14 illustrates a configuration of the voltage phase adjuster 7. The voltage phase adjuster 7 has voltage amplitude calculators 61a and 61b, an adder 62, and a correction unit 63. First, the voltage amplitude calculators 61a and 61b each obtain a voltage command amplitude (V1*) and a voltage command phase (δV1*) by the following formulas, by the use of the voltage command values (Vd* and Vq*) of the d axis and the q axis obtained by the voltage command value maker 3.

$$V 1 *= \sqrt{ } ( Vd * \hat{} 2 + Vq * \hat{} 2 )$$

$$δ V 1 *= {tan}^{- 1} ( - \frac{Vd *}{Vq *} )$$

FIG. 15 illustrates the voltage command phase. As shown in FIG. 15, the voltage command amplitude (V1*) and the phase (δV1*) are defined from the voltage command values (Vd* and Vq*) of the d axis and the q axis. Furthermore, the voltage command phase (δV1*) is a phase angle in a counterclockwise direction (the rotation direction of the motor 6) based on the q axis.

The adder 62 adds the amount of voltage phase adjustment (δVtrq) obtained by the period torque estimation unit 30 to the voltage command phase (δV1*). Thereafter, the correction unit 63 obtains the voltage command values (Vd** and Vq**) of the d axis and the q axis after the correction from the voltage command amplitude (V1*) and the output of the adder 62. Thereby, the voltage phase changes in synchronization with the load torque fluctuation.

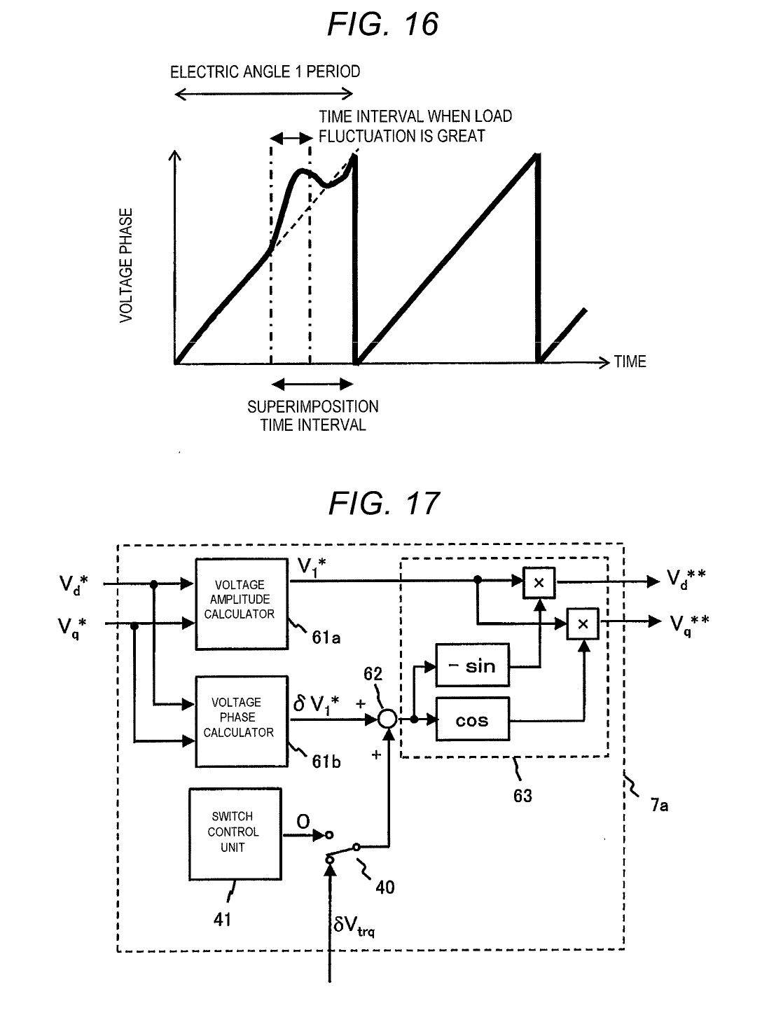

The voltage command values (Vd** and Vq**) after the correction are subjected to the coordinate conversion into the three-phase AC voltage by the dq/3φ converter 4. FIG. 16 illustrates a time change of the voltage phase that is output from the electric power conversion circuit 5. By the operation of the above-mentioned control unit 2, in the voltage phase that is output from the electric power conversion circuit 5, a second component, which changes in synchronization with the periodic load fluctuation of the compression mechanism unit 500, is superimposed on a first component that increases with respect to the magnetic pole position of the motor 6. The first component in this embodiment monotonically increases with respect to the magnetic pole position of the motor 6, and increases in proportion to the magnetic pole position of the motor 6. FIG. 16 illustrates a time interval when the load fluctuation is particularly great. Furthermore, in the period of the load fluctuation, the superimposition time interval, when the second component is superimposed on the first component, is a time interval when the load is equal to or greater than a predetermined threshold value (a predetermined value). For example, the superimposition time interval is from the middle of the compression process to the middle of the discharge process. For example, the predetermined threshold value is an average load torque, a value in which the average load torque is multiplied by a predetermined value, a value in which a predetermined value is added to the average load torque or the like.

FIG. 17 illustrates a modified example of the voltage phase adjuster 7. The voltage phase adjuster 7a is a modified example of the voltage phase adjuster 7. Compared to the voltage phase adjuster 7, the voltage phase adjuster 7a further has a switch 40, and a switch control unit 41. The switch 40 is provided in the input of amount of voltage phase adjustment (δVtrq) in the adder 62. The switch control unit 41 turns the control signal O on, when the rotation angle is within the range of the rotation angle corresponding to the time interval when the load is equal to or greater than a predetermined threshold value, in the period of the fluctuation of the load. The switch 40 is opened or closed, depending on the control signal O. Thereby, only in the time interval when the load is equal to or greater than the predetermined threshold value, the adder 62 adds the amount of voltage phase adjustment (δVtrq) to the voltage command phase (δV1*). Thereby, it is possible to suppress the periodic load fluctuation in the weak field magnetic region, while succeeding to the characteristics of other vector controls to the maximum, that is, minimizing the influence to another vector control work.

Combination with Voltage Phase Operation Type Weak Field Magnetic Control

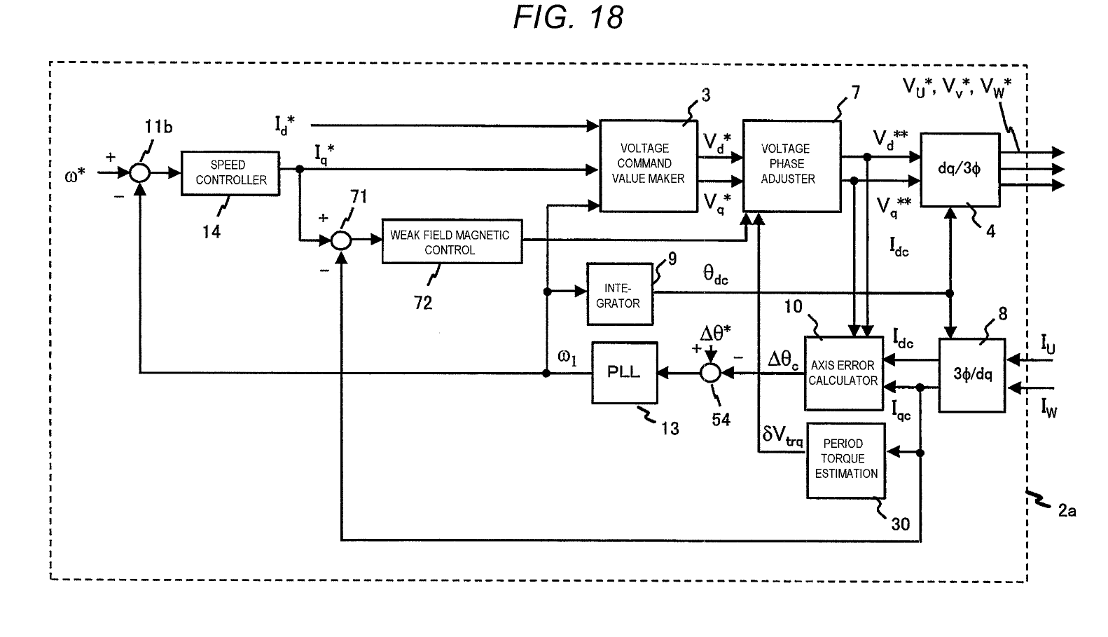

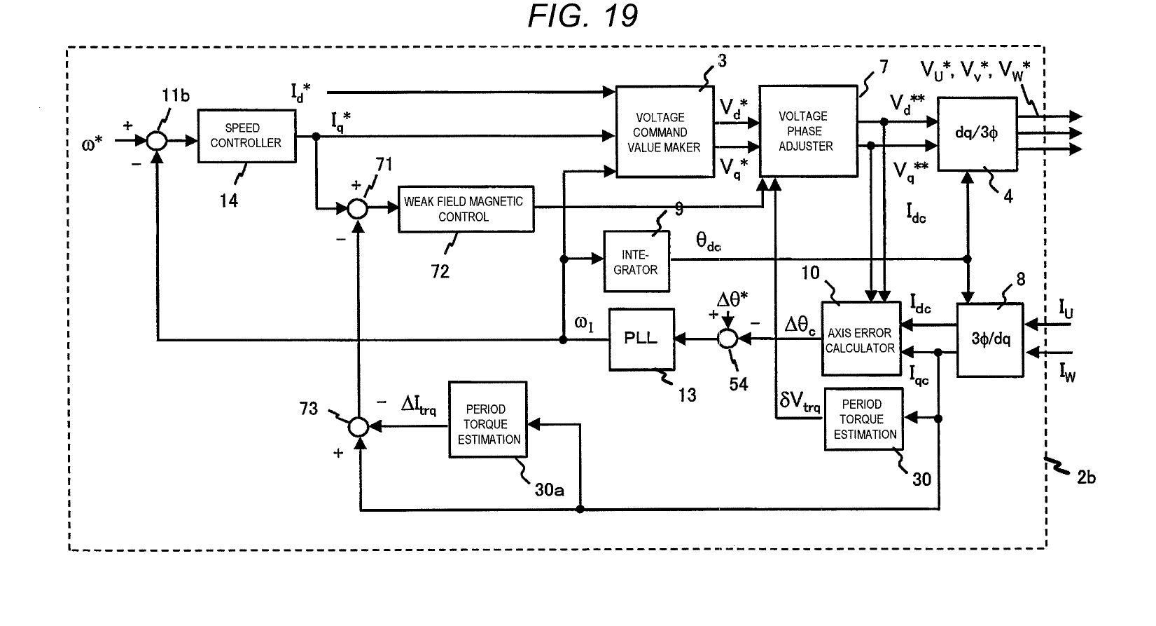

As mentioned above, when there is a high periodic load torque fluctuation even in a high speed region, such as the motor 6, the compression mechanism unit 500 or the like having the small inertia moment, there is also a need to suppress the periodic load fluctuation in the weak field magnetic region. FIG. 18 illustrates a first modified example of the control unit 2. The motor control device 1 of this case has a control unit 2a instead of the control unit 2. Compared to the control unit 2, the control unit 2a has a subtracter 71 and a weak field magnetic control unit 72, instead of the electric current controllers 15a and 15b. The subtracter 71 subtracts the q axis electric current detection value (Iqc) from the q axis electric current command value (Iq*). The weak field magnetic control unit 72 controls the voltage phase adjuster 7, by the use of the output of the subtracter 71.

The weak field magnetic control unit 72 fixes the amplitude of the voltage command value to a predetermined maximum value, and operates the voltage command value on the basis of a deviation between the q axis electric current command value (Iq*) and the q axis electric current detection value (Iqc). That is, when the load torque of the motor 6 increases (Iqc<Iq*), the voltage phase is increased to more strongly perform the weak field magnetic control. Thus, this motor control method is compatible with above-mentioned other motor control methods, and is able to easily suppress the periodic load fluctuation even in the weak field magnetic region.

In the response frequency in the weak field magnetic control, the maximum response frequency capable of being set by the electric constant of the motor 6 is defined. For that reason, if the response frequency of the weak field magnetic control is set beyond the upper limit value, the motor 6 becomes unstable.

FIG. 19 illustrates a second modified example of the control unit 2. When there is a limitation of the response frequency of the weak field magnetic control, the motor control device 1 has a control unit 2b instead of the control unit 2a. Compared to the control unit 2a, the control unit 2b further has a period torque estimation unit 30a, and a subtracter 73. The period torque estimation unit 30a estimates an amount of electric current phase adjustment (ΔItrq) from the q axis electric current detection value (Iqc). The subtracter 73 subtracts the amount of electric current phase adjustment (ΔItrq) from the q axis electric current detection value (Iqc). The subtracter 71 subtracts the output of the subtracter 73 from the q axis electric current command value (Iq*). In the weak field magnetic control of the control unit 2b, in the q axis electric current detection value, only basic wave components except the periodic fluctuation are controlled. When controlling only the periodic basic wave components, the required response frequency can be lowered compared to a case of also controlling the fluctuation. Thereby, there are advantages in that the calculation load of the microcomputer can be reduced, and the choice of the kinds of the microcomputer can be widened. That is, the cost of the microcomputer can be reduced. In addition, basically, the period torque estimation unit 30a can be realized by the same configuration as that of the period torque estimation unit 30.

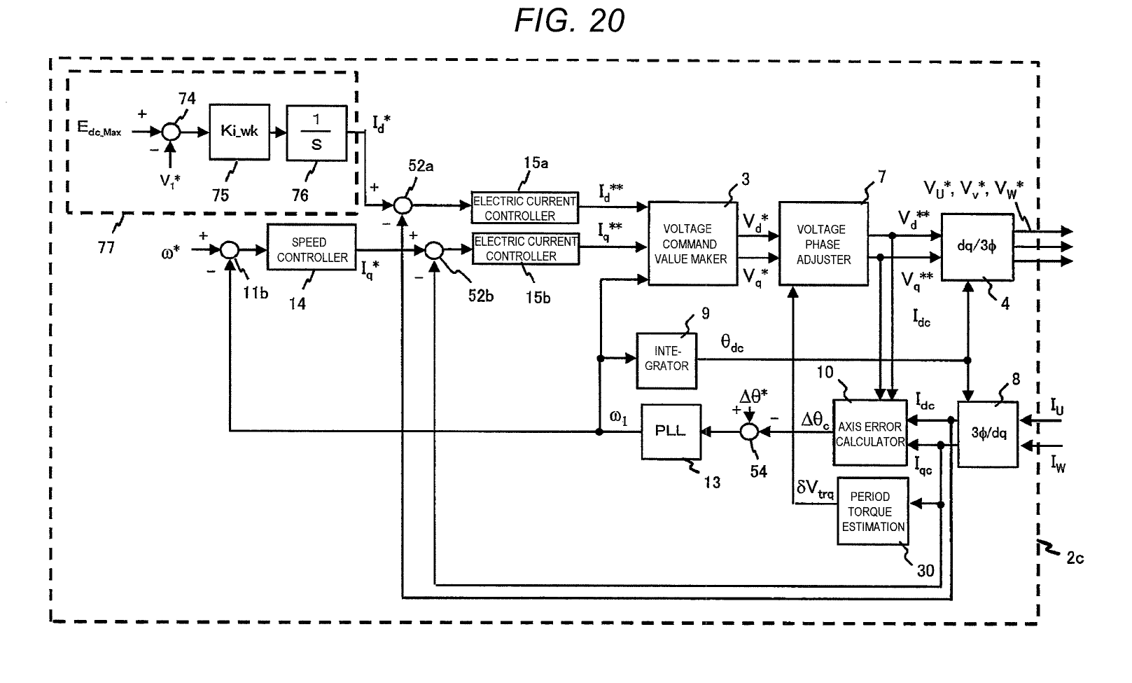

FIG. 20 illustrates a third modified example of the control unit 2. In this case, the motor control device 1 has a control unit 2c instead of the control unit 2. Compared to the control unit 2, the control unit 2c further has a d axis electric current command value determination unit 77. The d axis electric current command value determination unit 77 has a subtracter 74, an amplifier 75, and an integrator 76. The subtracter 74 subtracts the voltage command amplitude (V1*) from a voltage command amplitude maximum value (Edc_Max). The amplifier 75 multiplies the output of the subtracter 74 by a gain (Ki_wk). The integrator 76 calculates an axis electric current command value (Id*) by integrating the output of the amplifier 75.

Thereby, the d axis electric current command value determination unit 77 determines the d axis electric current command value so that the amplitude of the voltage command value does not exceed the voltage of the DC voltage source 20, comparing the voltage command amplitude (V1*) to the voltage command amplitude maximum value (Edc_Max). This motor control method indirectly adjusts the phase of the voltage command value, and compared to the above-mentioned other motor control methods, over-shoot and under-shoot of the voltage command value are easily generated. However, by being combined with the configuration of the above-mentioned period torque estimation unit 30 and the voltage phase adjuster 7, such problems can be solved, and thus more stable motor driving can be realized.

By the use of the period torque estimation unit and the voltage phase adjuster as mentioned above, the periodic load fluctuation can be suppressed regardless of the number of revolutions of the motor 6, and thus the motor 6 can be stably driven. Furthermore, in order to estimate the fluctuation of the load torque, it is evident that this embodiment can be applied to any compression type, without being limited to a specific compression type.

Furthermore, a suction pressure Ps and a discharge pressure Pd in one process of the compression mechanism unit 500 are changed by the state of a system (for example, a refrigerating cycle) to which the compression mechanism unit 500 is connected. Thereby, the load torque fluctuation in one process occurs. For that reason, the load torque fluctuation is estimated, the information thereof is input to the voltage phase adjuster 7, and the voltage phase is adjusted, whereby the present invention can be applied to a compression mechanism of various load characteristics.

The drive apparatus may have a mechanism unit having load torque characteristics that periodically fluctuate, without being limited to the compression mechanism. It is needless to say that the drive apparatus having the different mechanism unit exhibits the same effects as the drive apparatus of Embodiment 1.

### Modified Example of Compression Mechanism Unit 500

In the above-mentioned description, the shaft 502 of the motor 6 is connected to the piston 501 of the compression mechanism unit 500 via a crank shaft 503. For that reason, a series of processes as the compression mechanism unit 500 becomes a mechanical angle 1 period, and as a result, the fluctuation of the load torque is also the mechanical angle 1 period. For example, when adding a gear between the shaft of the motor 6 and the crank shaft 503, the fluctuation of the load torque fluctuates by the integral multiplication of the mechanical angle 1 period. Even in this case, if the fluctuation period of the load torque is known in advance, the contents described in this embodiment can be applied, and the same effects can be exhibited.

### Embodiment 2

### Application Example to Refrigerator

In this embodiment, a refrigerator 301 as an application example of the motor control device of the present invention will be described.

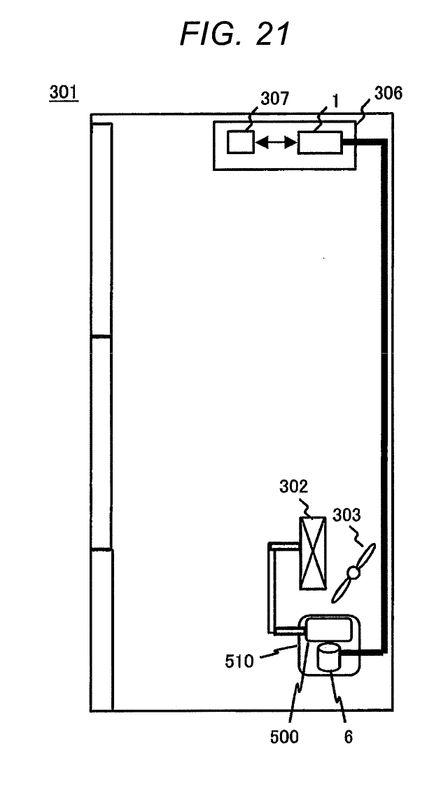

FIG. 21 illustrates a configuration of the refrigerator in Embodiment 2. In addition, in this embodiment, the description of the units having the same functions as the configurations denoted by the same reference numerals as Embodiment 1 will be omitted.

The refrigerator 301 has a heat exchanger 302, a blower 303, a compressor 510, and a refrigerator control unit 306. The heat exchanger 302 cools the ambient air using the refrigerant. The blower 303 causes the air cooled by the heat exchanger 302 to circulate in the refrigerator 301. The compressor 510 has the motor 6, and the compression mechanism unit 500, like in Embodiment 1. The compression mechanism unit 500 compresses and cools the refrigerant. The motor 6 drives the compression mechanism unit 500.

The refrigerator control unit 306 has an internal control device 307 that controls the blower 303, an oven light or the like by information from various sensors provided in the refrigerator 301, and the motor control device 1 that controls the motor 305 for driving the compressor. The motor control device 1 is the same as that of Embodiment 1.

In the refrigerator 301, there is a very small amount of heat leak leaking to the outside air from the inside of the refrigerator 301, through a vacuum insulation material or the like. In such a refrigerator 301, in order to further reduce the amount of the power consumption of the motor control device 1, for example, it is effective to control the DC voltage to the optical value, by adding a buck-boost converter 81 to the electric power conversion circuit 5. The motor control device 1 of this embodiment has an electric power conversion circuit 5a instead of the electric power conversion circuit 5. The electric power conversion circuit 5a suppresses the periodic load fluctuation even when controlling the DC voltage. Thereby, the motor control device 1 is provided that stably controls the motor 6.

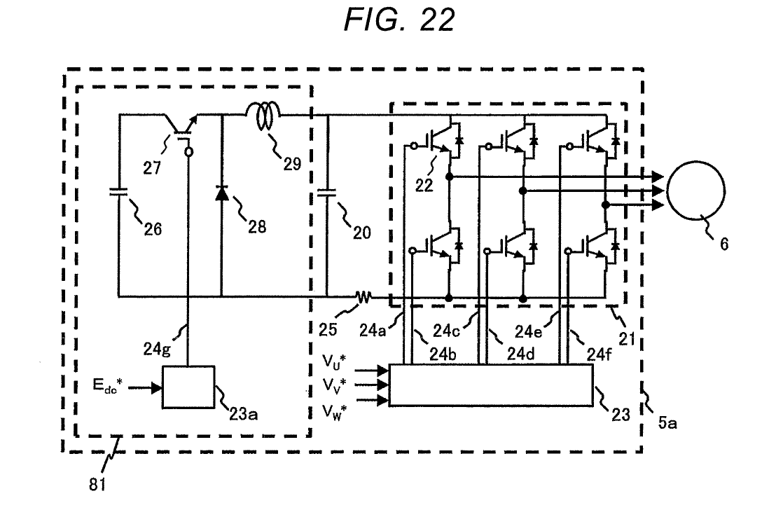

FIG. 22 illustrates a configuration of the electric power conversion circuit 5a in Embodiment 2. Compared to the electric power conversion circuit 5, the electric power conversion circuit 5a further has a buck-boost converter 81. The buck-boost converter 81 has a drive circuit 23a, a capacitor 26, a switching element 27, a diode 28, and an inductor 29. The driver circuit 23a switches the switching element 27 by a specific duty so as to cause the voltage of the DC voltage source 20 to follow the DC voltage command value (Edc*). The DC voltage command value (Edc*) of the electric power conversion circuit 5a is given by a higher control system or the like in advance, or is determined by a ratio between the voltage command amplitude (V1*) and the induced voltage of the motor 6.

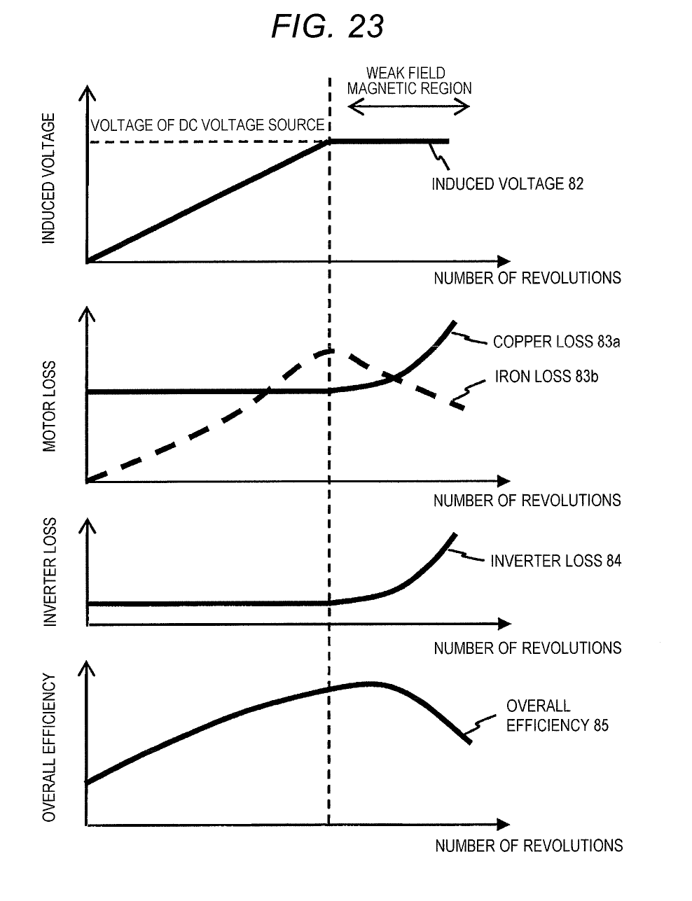

FIG. 23 illustrates efficiency with respect to the number of revolutions of the motor 6. FIG. 23 illustrates an induced voltage 82, a motor loss 83, an inverter loss 84, and an overall efficiency 85 with respect to the number of revolutions of the motor 6. The overall efficiency 85 is efficiency that multiplies the efficiency of the motor 6 by the efficiency of the electric power conversion circuit 5a. The loss of the motor 6 mainly includes a copper loss 83a that is proportional to a square of the motor electric current, and an iron loss 83b that increases depending on the inverter frequency (the number of revolutions) in a normal region. Since an amount of magnetic flux equivalently decreases in a weak field magnetic region, the iron loss 83b decreases. Although a ratio between the copper loss 83a and the iron loss 83b depends on the design of the motor 6, for example, as illustrated in FIG. 23, in the case of the motor 6 having the high ratio of the iron loss 83b, the loss is lowest near the region in which the number of revolutions enters the weak field magnetic region. Meanwhile, in the efficiency of the electric power conversion circuit 5a, the loss proportional to the square of the electric current is important. For that reason, by the combination of the motor 6 and the electric power conversion circuit 5a, in the overall efficiency 85, the loss is lowest in the region near entering the weak field magnetic region. Thus, when using the electric power conversion circuit 5a of this embodiment, by controlling the DC voltage of the electric power conversion circuit 5a to a value that is equivalent to the induced voltage 82 of the motor 6, the loss of the motor control device 1 is suppressed. In other words, the motor control device 1 is able to realize the high efficiency of the motor control device 1 in the wide range of the number of revolutions, by driving the motor 6 near the weak field magnetic region, regardless of the number of revolutions.

In this manner, when the weak field magnetic control is used in a wide range of the number of revolutions without being limited to the high-speed region, the motor control device 1 of this embodiment is effective. The reason is that, there is no need to change the motor control method of suppressing the periodic load fluctuation between the normal region and the weak field magnetic region, by changing the voltage phase in synchronization with the periodic load fluctuation of the mechanism unit, and a transient problem (electric current fluctuation, frequency fluctuation or the like) when converting a plurality of control works does not occur.

### Modified Example of Embodiment 2

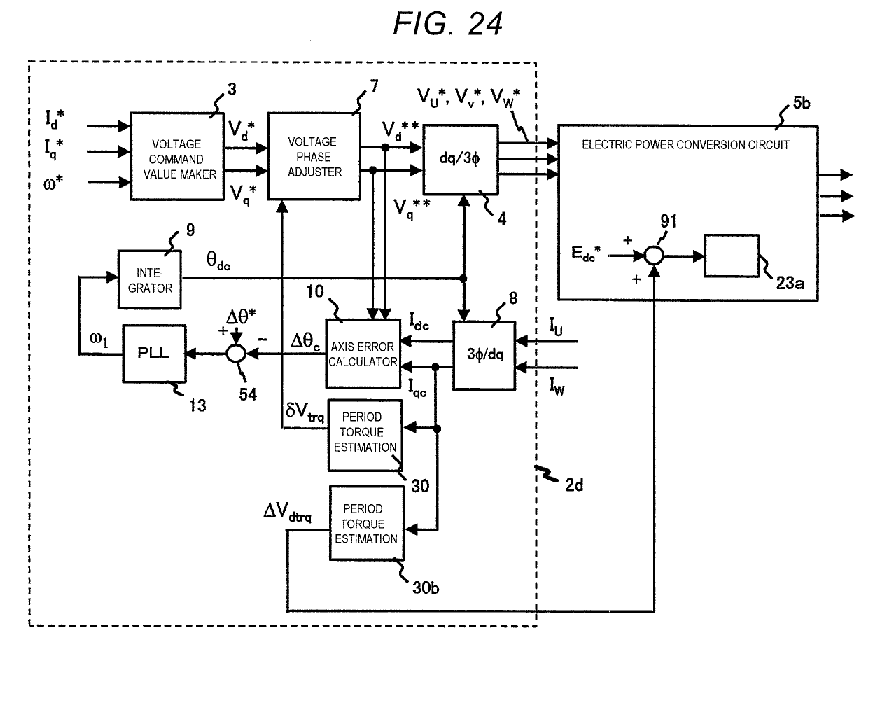

FIG. 24 illustrates a modified example of the control unit and the electric power conversion circuit in Embodiment 2. The motor control device 1 of this case has a control unit 2d instead of the control unit 2, and has an electric power conversion circuit 5b instead of the electric power conversion circuit 5a.

Compared to the control unit 2, the control unit 2d further has a period torque estimation unit 30b. The period torque estimation unit 30b estimates the load torque component periodically fluctuating, on the basis of the electric current information detected in the electric current detection unit 12, like the period torque estimation unit 30. The period torque estimation unit 30b multiplies the change of the estimated load torque by a gain (Ktrq) as needed, and obtains an amount of DC voltage command adjustment (ΔVdtrq).

Compared to the electric power conversion circuit 5a, the electric power conversion circuit 5b further has an adder 91. The adder 91 calculates and inputs the DC voltage command value after the adjustment to the driver circuit 23a, by adding the amount of DC voltage command adjustment (ΔVdtrq) to the DC voltage command value (Edc*). The DC voltage command value (Edc*) is given in advance by a higher control system or the like, or is determined by a ratio between the voltage command amplitude (V1*) and the induced voltage of the motor 6.

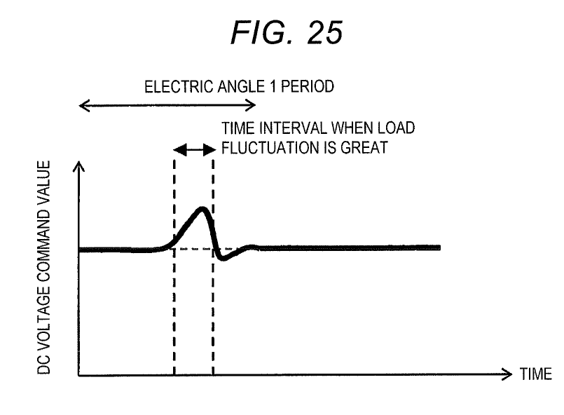

FIG. 25 illustrates a time change of the DC voltage command value after the adjustment. With the change in the DC voltage command value after the adjustment shown in FIG. 25, the rapid change of the weak field magnetic control state due to a periodic change in load torque is suppressed. Thereby, it is possible to maintain driving of the motor 6 near the weak field magnetic region and realize the high efficiency of the refrigerator 301. In addition, when there is a fluctuation in voltage supplied to the DC voltage source 20 of the electric power conversion circuit 5b, the influence (ripple) of the fluctuation is superimposed on the voltage of the DC voltage source 20. For example, when using the single-phase AC voltage source, in some cases, the ripple twice the power source frequency may be superimposed, depending on the type of a rectifier circuit and the capacity of a smoothing capacitor.

By the use of any one of the configuration examples of the period torque estimation unit and the voltage phase adjuster mentioned above, it is possible to suppress the periodic load fluctuation and stably drive the motor 6, regardless of the number of revolutions of the motor 6. Thereby, it is possible to suppress the vibration due to the periodic fluctuation of the load and the consequent noise in the refrigerator 301.

The above-mentioned embodiments were described on the assumption of the feed-back control. For that reason, the control unit 2 detects and controls the periodic load fluctuation. However, for example, the control unit 2 is able to obtain the same effects as the above-mentioned embodiments, by preserving the data showing a change in the periodic load torque in advance, and calculating the amount of voltage phase adjustment and the amount of DC voltage command adjustment on the basis of the data.

The above-mentioned embodiments can also be applied to other drive apparatuses that drive the mechanism unit by the motor, such as a freezing machine and an air-conditioner (an air conditioning apparatus).

Furthermore, the motor control device 1 can be applied, regardless of the structure of the motor 6 and the type of the mechanism unit. In the above-mentioned embodiments, although a case was described where the motor 6 was a permanent magnet motor, other electric motors (for example, an induction machine, a synchronous machine, a switched reluctance motor, a synchronous reluctance motor or the like) may be used, instead of the permanent magnet motor. At that time, although the calculation method in the voltage command value maker changes depending on the electric motors, the others can be similarly applied, and the same effects as the above-mentioned embodiments can be obtained.

In addition, the present invention is not limited to the above-mentioned embodiments, but various modified examples are included. For example, the above-mentioned embodiments were described in detail in order to easily describe the present invention, but are not necessarily limited to the aspect that includes all the described configurations. Furthermore, a part of the configuration of any embodiment can also be replaced with the configuration of another embodiment, and the configuration of another embodiment can also be added to the configuration of any embodiment. Furthermore, in regard to a part of the configuration of each of the embodiments, the addition, the deletion, and the replacement of another configuration can be made.

Furthermore, a part or all of each of the configurations, the functions, the processing units, the processing procedures or the like mentioned above may be realized in hardware, for example, by being designed in an integrated circuit or the like. Furthermore, each of the configurations, the functions or the like mentioned above may be realized in software, by interpreting and executing the program for realizing each of the functions through a processor.

In addition, the motor control device 1 may have a load fluctuation detection unit that detects the periodic fluctuation of the load of the motor, based on the detected electric current, without being limited to the period torque estimation unit. Furthermore, the motor control device 1 may have an adjustment unit that adjusts the phase of the AC voltage of the AC electric power, by controlling the electric power conversion circuit based on the fluctuation of the load, without being limited to the voltage phase adjustment unit. Furthermore, the motor control device 1 may have a DC voltage adjustment unit that changes the DC voltage in synchronization with the fluctuation of the load torque, without being limited to the buck-boost converter.

The techniques described in the above-mentioned embodiments can be expressed as follows.

### Expression 1

A motor control device that includes

an electric power conversion circuit that supplies AC electric power to a motor configured to drive a mechanism unit by converting DC electric power into the AC electric power;

an electric current detection unit that detects the electric current flowing through the electric power conversion circuit or the motor;

a load fluctuation detection unit that detects the periodic fluctuation of the load of the motor, based on the electric current; and

an adjustment unit that adjusts the phase of the AC voltage of the AC electric power, by controlling the electric power conversion circuit based on the fluctuation,

wherein the period of the fluctuation is an integer multiplication of a mechanical angle 1 period of the motor, and

the phase of the AC voltage has a first component that increases with respect to a magnetic pole position of the motor, and a second component that changes in synchronization with the fluctuation.

### Expression 2

A refrigerator that includes

a compression mechanism unit that compresses a refrigerant;

a motor that drives the compression mechanism unit;

an electric power conversion circuit that supplies AC electric power to the motor by converting DC electric power into the AC electric power;

an electric current detection unit that detects the electric current flowing through the electric power conversion circuit or the motor;

a load fluctuation detection unit that detects the periodic fluctuation of the load of the motor, based on the electric current; and

an adjustment unit that adjusts a phase of an AC voltage of the AC electric power, by controlling the electric power conversion circuit based on the fluctuation,

wherein a period of the fluctuation is an integer multiplication of a mechanical angle 1 period of the motor, and

the phase of the AC voltage has a first component that increases with respect to a magnetic pole position of the motor, and a second component that changes in synchronization with the fluctuation.

### Expression 3

A method of controlling a motor that includes:

supplying AC electric power to a motor configured to drive a mechanism unit, by converting DC electric power into the AC electric power;

detecting the electric current flowing through the electric power conversion circuit or the motor;

detecting the periodic fluctuation of a load of the motor, based on the electric current; and

adjusting a phase of an AC voltage of the AC electric power, by controlling the electric power conversion circuit based on the fluctuation,

wherein a period of the fluctuation is an integer multiplication of a mechanical angle 1 period of the motor, and

the phase of the AC voltage has a first component that increases with respect to a magnetic pole position of the motor, and a second component that changes in synchronization with the fluctuation.

What is claimed is:

1. A motor control device comprising:
an electric power conversion circuit that supplies AC electric power to a motor configured to drive a mechanism unit, by converting DC electric power into the AC electric power;
an electric current detection unit that detects the electric current flowing through the electric power conversion circuit or the motor;
a load fluctuation detection unit that detects the periodic fluctuation of the load of the motor, based on the electric current; and
an adjustment unit that adjusts a phase of an AC voltage of the AC electric power, by controlling the electric power conversion circuit based on the fluctuation,
wherein a period of the fluctuation is an integer multiplication of a mechanical angle 1 period of the motor, and
the phase of the AC voltage has a first component that increases with respect to a magnetic pole position of the motor, and a second component that changes in synchronization with the fluctuation.

2. The motor control device according to claim 1, wherein the number of revolutions of the motor is the number of revolutions of a case where an induced voltage of the motor is equal to or greater than a DC voltage of the DC electric power.

3. The motor control device according to claim 1,
wherein the adjustment unit adds the second component to the first component of the phase of the AC voltage, in a time interval when the load is equal to or greater than a predetermined value in the period of the fluctuation.

4. The motor control device according to claim 3,
wherein the adjustment unit adds the second component to the first component of the phase of the AC voltage using a range of a rotation angle of the motor corresponding to the time interval, when the rotation angle of the motor is within the range.

5. The motor control device according to claim 1, further comprising:
a DC voltage adjustment unit that changes the DC voltage in synchronization with the fluctuation, by controlling the DC voltage of the DC electric power based on the fluctuation.

6. The motor control device according to claim 1,
wherein the first component increases in proportion to the magnetic pole position.

7. The motor control device according to claim 1,
wherein the electric power conversion circuit has a switching element.

8. A refrigerator comprising:
a compression mechanism unit that compresses a refrigerant;
a motor that drives the compression mechanism unit;
an electric power conversion circuit that supplies AC electric power to the motor, by converting DC electric power into the AC electric power;
an electric current detection unit that detects the electric current flowing through the electric power conversion circuit or the motor;
a load fluctuation detection unit that detects the periodic fluctuation of the load of the motor, based on the electric current; and
an adjustment unit that adjusts a phase of an AC voltage of the AC electric power, by controlling the electric power conversion circuit based on the fluctuation,
wherein a period of the fluctuation is an integer multiplication of a mechanical angle 1 period of the motor, and
a phase of the AC voltage has a first component that increases with respect to a magnetic pole position of the motor, and a second component that changes in synchronization with the fluctuation.
